(19) United States
(12) Patent Application Publication
(10) Pub. No.: US 2008/0196103 A1
(43) Pub. Date: Aug. 14, 2008

(54) METHOD FOR ANALYZING ABNORMAL NETWORK BEHAVIORS AND ISOLATING COMPUTER VIRUS ATTACKS

(76) Inventors: Chao-Yu Lin, Kaohsiung City (TW); Chao-Ju Chen, Kaohsiung City (TW); Shu-Chuan Chang, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/673,121

(22) Filed: Feb. 9, 2007

(51) Int. Cl. G06F 11/30

(52) U.S. Cl. 726/24

(57) ABSTRACT

A method for analyzing abnormal network behaviors and isolating computer virus attacks comprises network equipments controlled by an automatic program so as to have a serious of processes of a packet analyzing, an identity locking and an instant isolating. By using a network monitoring module or/and a network identity module involved in the automatic program to simultaneously deal with the processes of the packet analyzing and the identity locking, and then by using an automatic locking module also involved in the automatic program to execute the process of the instant isolating, the viruses are appropriately isolated and then antivirus softwares scan the infected computer so as to have a problem solving, thereby obtaining a restoring.

### BACKGROUND OF THE INVENTION

1. Field of the Invention

The present invention relates to a method for analyzing abnormal network behaviors and isolating computer virus attacks, and more particularly to an automatic detecting and isolating method for use in intruded viruses on the network.

2. Description of the Prior Arts

In early days, viruses intruded computer through disks, yet current viruses globally spread to and attack the computers through network. Although almost every computer is installed an antivirus software thereon, the antivirus effect is limited, especially if an instant update of an antivirus software is not available, a virus infection of the computer or a denial of the corporate intranet probably occurs.

Because the transmitting of internet is to divide a file into several data packets, the infected file through the transmitting of internet is also divided into several ones. Hence, to protect the system from a virus attack, an assortment of packet filtering technologies have been developed, wherein the firewall and IDS (Intrusion Detection System) are responsible for the first-line and the second-line security protection job of the whole internet respectively. In addition, to supplement the insufficient security protection, more and more security products, such as IPS (Intrusion) or IDP (Intrusion Detection Protection) are subscribed by companies. Nevertheless, if an instant update of antivirus software is not available, a virus infection of the computer or a denial of the corporate intranet still occurs. Likewise, current network management tools which include network flow, bandwidth, error packet provided by Cisco & Foundry and the like companies and CPU loading, are used to maintain the normal operation of network. Any attack behaviors of causing network denial as show in the following table 1 must have a period of time to prepare, unfortunately, during this period of time the sent packet for warning virus attack is quite less, so that the network management tools can not immediately distinguish if abnormal behaviors cause, thus the problem such as the long downtime or the virus infections of network can not be efficiently solved.

TABLE 1

| step | methods |
|---|---|
| preparing step | ping, whois . . . |
| | IP spoofing |
| | Nmap, Nessus . . . |
| | sniffer 5 |
| attacking and occupying step | password crack |
| | exploil |
| | Read, write, copy |
| | Trojan horse |
| destroying step | DDoS |

The present invention has arisen to mitigate and/or obviate the afore-described disadvantages.

### SUMMARY OF THE INVENTION

The primary objective of the present invention is to provide a method for analyzing abnormal network behaviors and isolating computer virus attacks, which can employ the automatic programs to control existed network equipment so as to distinguish the abnormal behaviors without changing corporate intranet, thereby shortening the searching time of the abnormal behaviors, and then instantly locking and isolating the abnormal host, such that a serious of problems, such as discovering/analyzing/isolating/solving/restoring/reopening, can be effectively dealt with by ways of various kinds of functions involved in the programs.

The method for analyzing abnormal network behaviors and isolating computer virus attacks of the present invention includes using a network monitoring module and a network identity module to execute a step of collecting and analyzing a statistic data flow immediately so as to find out and lock the attack source for executing a further step of judging if the attack source crosses a set threshold parameter of the network monitoring module, if the attack source does not cross the set threshold parameter of the network monitoring module, an exclusion causing, or further executing a step of judging whether the attack source exists in an exception list of a quota of a daily data flow, an abnormal warning sent to the manager at instant if the attack source does not exist in the exception list of the quota of the daily data flow, and an automatic locking module started to lock the attack source so as to isolate the abnormal computer from other computers, thus stopping the virus attack and finding out the location of the attack computer for having a virus scanning by various types of antivirus softwares, if the attack source exists in the exception list, it processed in a further step of determining if the attack source exists in specific items of the exception list of the quota of the daily data flow, if not, an exclusion causing, or having a further step of determining whether the attack source crosses the specific items of the exception list, if the result is “no”, the exclusion occurring, or an abnormal warning also sent to the manager at instant, and the automatic locking module started to lock the attack source so as to isolate the abnormal computer from other computers, thus stopping the virus attack and finding out the location of the attack computer for having a virus scanning by the antivirus softwares.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a block diagram of a method for analyzing abnormal network behaviors and isolating computer virus attacks in accordance with the present invention;

FIG. 2 is a flow chart of an abnormal processing of the method for analyzing abnormal network behaviors and isolating computer virus attacks of the present invention.

### DETAILED DESCRIPTION OF THE PREFERRED EMBODIMENT

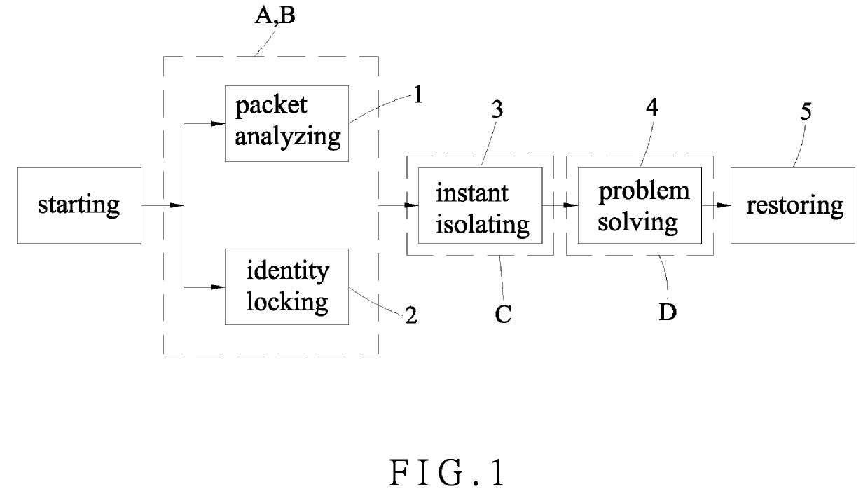

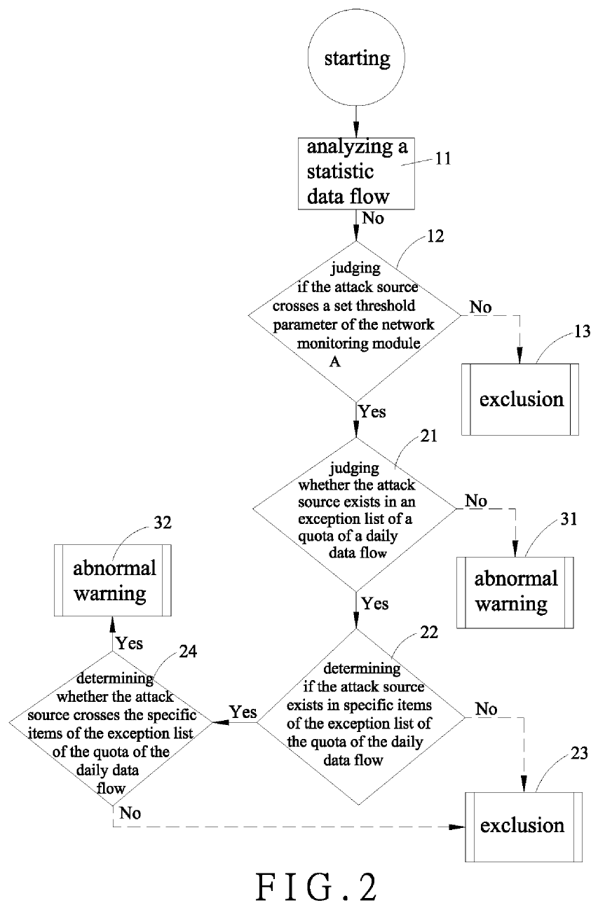

Referring to FIGS. 1 and 2, a method for analyzing abnormal network behaviors and isolating computer virus attacks in accordance with the present invention is shown and comprises network equipments (e.g., hubs, switches, router switches and the like) controlled by an automatic program so as to have a serious of processes of a packet analyzing 1, an identity locking 2 and an instant isolating 3. By using a network monitoring module A or/and a network identity module B involved in the automatic program to simultaneously deal with the processes of the packet analyzing 1 and the identity locking 2, and then by using an automatic locking module C also involved in the automatic program to execute the process of the instant isolating 3, the viruses are appropriately isolated and then antivirus softwares D scan the infected computer so as to have a problem solving 4, thereby obtaining a restoring 5.

The network monitoring module A is employ a Netflow/Sflow/SNMP (Simple Network Management Protocol)/Mirror Port to collect and analyze the data flow of all computers of the network architecture in a certain time (such as in ten minutes) so as to distinguish whether abnormal network behaviors occur, such that an earlier prevention of the network denial behavior can be achieved. The Netflow, Sflow and Mirror Port are the third layer of network protocol, yet the SNMP is the second layer of network protocol. Furthermore, the collected data include the record of the linking number (source IP/per ten minutes), the record of the linked number (destination IP/per ten minutes), the record of the number of the source port (linking establishment/per ten minutes), the record of the number of the destination port (linked establishment/per ten minutes), the record of the linking number of UDP (User Datagram Protocol)/per ten minutes, the record of the linking number of TCP (Transmission Control Protocol)/per ten minutes, the record of the linking number of ICMP (Internal Control Message Protocol)/per ten minutes, the amount record of Octets/per ten minutes, the amount record of Packets/per ten minutes, and the amount record of Flow/per ten minutes, etc,. The network monitoring module A reviews the collected data flow and sets a threshold for the network flow based on the use states of the respective corporate intranets. To distinguish the limitation of the sever and the common host, the network monitoring module A makes an exception list of a quota of a daily network flow which includes some special equipment (e.g., a certain computer with larger linking amount) or DNS, FTP and the like Server Farm. According to the exception list, the specific items of exception list of the quota of the daily network flow are set as well. The specific items include some unlocked IPs or the computers with larger linking amount, thereby setting a standard limitation of the sever. In addition, determining abnormal network behaviors is to utilize a data sort function to clearly show the linking state between the source and destination hosts, for example, identifying whether a host processes a behavioral mode of one-to-many linking in accordance with a source IP or a destination IP, identifying whether a host processes a one-to-one Port-scanning in accordance with a source IP Port or a destination IP Port, or having a DDoS (Distributed Denial of Service) and so on.

The network identity module B is allowed to support the second layer of SNMP by using the IP address shown in the network monitoring module A to form an IP/MAC (Media Access control) table so as to crossly check out the corresponding computer location by using the known IP address to check the network architecture, and then according to whether the user's identity exists in the exception list of the quota of the daily network flow to determine if the network is available.

The automatic locking module C can automatically command the network equipment to isolate the attack source through inner known functions thereof. Such an operational way includes applying ACLs (Access Control Lists) involved in the third layer of network equipment (such as a router switch) to lock the attack source IP, and the command syntax of the automatic locking module C can simultaneously support the network protocol formats produced by the system maker, e.g., Foundry and Cisco, etc. Likewise, another operational way is to utilize the second layer of network equipment (such as a switch) of the SNMP to cooperate with the network identity module B for forming an IP/MAC table, thereby directly closing the port of the network equipment of the attack source IP.

With reference to FIG. 2, the steps of the method for analyzing abnormal network behaviors and isolating computer virus attacks in accordance with the present invention include using either or both of the network monitoring module A and the network identity module B to execute a step 11 of collecting and analyzing a statistic data flow immediately so as to find out and lock the attack source for executing a further step 12 of judging if the attack source crosses a set threshold parameter of the network monitoring module A. If the attack source does not cross the set threshold parameter of the network monitoring module A, an exclusion 12 causes, or further executing a step 21 of judging whether the attack source exists in an exception list of a quota of a daily data flow. An abnormal warning 31 is sent to the manager at instant if the attack source does not exist in the exception list of the quota of the daily data flow, and an automatic locking module C is started to lock the attack source so as to isolate the abnormal computer from other computers, thus stopping the virus attack and finding out the location of the attack computer for having a virus scanning by various types of antivirus softwares D. If the attack source exists in the exception list, it is processed in a further step 22 of determining if the attack source exists in specific items of the exception list of the quota of the daily data flow, if not, an exclusion 23 causes, or having a further step 24 of determining whether the attack source crosses the specific items of the exception list, if the result is “no”, the exclusion 23 occurs, or an abnormal warning 32 is also sent to the manager at instant and an automatic locking module C is started to lock the attack source so as to isolate the abnormal computer from other computers, thus stopping the virus attack and finding out the location of the attack computer for having a virus scanning by the antivirus softwares D.

To summarize, the present invention has the following advantages:

First, the present invention can employ the automatic programs to control existed network equipment so as to distinguish the abnormal behaviors without changing corporate intranet, thereby shortening the searching time of the abnormal behaviors, and then instantly locking and isolating the abnormal host, such that a serious of problems, such as discovering/analyzing/isolating/solving/restoring/reopening, can be effectively dealt with by ways of various kinds of functions involved in the programs.

Second, the present invention can set the threshold, the exception list of the quota of the daily network flow and the specific items of the exception list depended on the use states of the respective cooperate intranets so that some problems, for example, some Server Farms or the special equipments are locked, can be avoidable.

Third, the method of automatically locking the attack source of the present invention can effectively prevent the virus from spreading on the corporate intranets and other subnets, thus saving the time and cost for updating virus code, and quickly discovering the abnormal IP/MAC and then scanning virus therein.

Fourth, the present invention can support the command syntaxes of a variety of network protocols and can directly download the updated programs on the internet or website, hence the internet manager has not to learn other command syntaxes.

Finally, the automatic isolating method of the present invention is not limited by IP, subnet or the user amount, yet only one host has to be installed on the corporate intranet, thus greatly decreasing the cost of internet management.

The invention is not limited to the above embodiment but various modifications thereof may be made. It will be understood by those skilled in the art that various changes in form and detail may made without departing from the scope and spirit of the present invention.

What is claimed is:

1. A method for analyzing abnormal network behaviors and isolating computer virus attacks comprising:
using a network monitoring module and a network identity module to execute a step of collecting and analyzing a statistic data flow immediately so as to find out and lock the attack source for executing a step of judging if the attack source crosses a set threshold parameter of the network monitoring module, if the attack source does not cross the set threshold parameter of the network monitoring module, an exclusion causing, or further executing a step of judging whether the attack source exists in an exception list of a quota of a daily data flow, an abnormal warning sent to the manager at instant if the attack source does not exist in the exception list of the quota of the daily data flow, and an automatic locking module started to lock the attack source so as to isolate the abnormal computer from other computers, thus stopping the virus attack and finding out the location of the attack computer for having a virus scanning by various types of antivirus softwares, if the attack source exists in the exception list, it processed in a further step of determining if the attack source exists in specific items of the exception list of the quota of the daily data flow, if not, an exclusion causing, or having a further step of determining whether the attack source crosses the specific items of the exception list, if the result is “no”, said exclusion occurring, or an abnormal warning is also sent to the manager at instant, and said automatic locking module started to lock the attack source so as to isolate the abnormal computer from other computers, thus stopping the virus attack and finding out the location of the attack computer for having a virus scanning by said antivirus softwares.

2. The method for analyzing abnormal network behaviors and isolating computer virus attacks as claimed in claim 1, wherein said network monitoring module is employ a supported, standard Protocol to collect and analyze the data flow of all computers of the network architecture in a certain time so as to distinguish whether abnormal network behaviors occur.

3. The method for analyzing abnormal network behaviors and isolating computer virus attacks as claimed in claim 2, wherein the command syntax of said network monitoring module can simultaneously support the third layer of the Netflow and Sflow of the network protocol format.

4. The method for analyzing abnormal network behaviors and isolating computer virus attacks as claimed in claim 2, wherein the command syntax of said network monitoring module can support the third layer of the Mirror Port of the network protocol as well.

5. The method for analyzing abnormal network behaviors and isolating computer virus attacks as claimed in claim 2, wherein the command syntax of said network monitoring module can support the second layer of the SNMP of the network protocol.

6. The method for analyzing abnormal network behaviors and isolating computer virus attacks as claimed in claim 1, wherein said network monitoring module can also find out and lock the attack source by cooperating with said network identity module.

7. The method for analyzing abnormal network behaviors and isolating computer virus attacks as claimed in claim 6, wherein said network identity module is allowed to support the second layer of SNMP by using the IP address shown in said network monitoring module to form an IP/MAC table so as to crossly check out the corresponding computer location by using the known IP address to check the network architecture.

8. The method for analyzing abnormal network behaviors and isolating computer virus attacks as claimed in claim 1, wherein the exception list of the quota of the daily network flow includes DNS, FTP and the like Server Farm for distinguishing the sever from the common host.

9. The method for analyzing abnormal network behaviors and isolating computer virus attacks as claimed in claim 1, wherein the exception list of the quota of the daily network flow includes special equipment (e.g., a certain computer with larger linking amount).

10. The method for analyzing abnormal network behaviors and isolating computer virus attacks as claimed in claim 1, wherein the specific items of the exception list of the quota of the daily network flow include some unlocked IPs.

11. The method for analyzing abnormal network behaviors and isolating computer virus attacks as claimed in claim 1, wherein said automatic locking module can automatically command the network equipment to isolate the attack source through inner known functions thereof.

12. The method for analyzing abnormal network behaviors and isolating computer virus attacks as claimed in claim 11, wherein an operational way of said automatic locking module includes applying ACLs involved in the third layer of network equipment (such as a router switch) to lock the attack source IP.

13. The method for analyzing abnormal network behaviors and isolating computer virus attacks as claimed in claim 11, wherein the command syntax of said automatic locking module can simultaneously support the network protocol formats produced by the system maker, e.g., Foundry and Cisco, etc.

14. The method for analyzing abnormal network behaviors and isolating computer virus attacks as claimed in claim 11, wherein another operational way of said automatic locking module is to utilize the second layer of network equipment (such as a switch) of the SNMP to cooperate with said network identity module for forming an IP/MAC table, thereby directly closing the port of the network equipment of the attack source IP.
